(19) United States
(12) Patent Application Publication
(10) Pub. No.: US 2009/0059131 A1
(43) Pub. Date: Mar. 5, 2009

(54) LAMP AND LIQUID CRYSTAL DISLAY INCLUDING THE SAME

(76) Inventors: Min-Jeong WANG, Seoul (KR); Hyuk-Hwan KIM, Asan-si (KR); Seok-Hyun NAM, Seoul (KR); Sang-Hyuck YOON, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 12/202,062

(22) Filed: Aug. 29, 2008

(30) Foreign Application Priority Data
Aug. 31, 2007 (KR) 2007-0088467

(51) Int. Cl. G02F 1/13357; H01J 63/04

(52) U.S. Cl. 349/69; 313/483; 313/491

(57) ABSTRACT

Disclosed is a lamp and a liquid crystal display device having the same. The lamp includes a discharge tube having an inner wall coated with a phosphor; a first electrode containing a first metallic material having a first sputtering rate provided at one end of the discharge tube; and a second electrode containing a second metallic material having a second sputtering rate provided at the other end of the discharge tube, wherein the first sputtering rate is larger than the second sputtering rate.

### CROSS-REFERENCE TO RELATED APPLICATIONS

This application claims priority under 35 U.S.C. §119 to Korean Patent Application No. 2007-0088467 filed in the Korean Intellectual Patent Office on Aug. 31, 2007, the contents of which are herein incorporated by reference in their entirety.

### BACKGROUND OF THE INVENTION

1. Field of the Invention

The present invention relates to a lamp and a liquid crystal display device having the same, and more particularly, to a low-cost and long-lifespan lamp and a liquid crystal display device having the same.

2. Description of the Related Art

Generally, liquid crystal display (“LCD”) devices display images by using electro-optical properties of liquid crystal. An LCD device includes an LCD panel and a backlight unit. The backlight unit supplies the LCD panel with the light necessary to display images.

The backlight unit includes a light source and an optical sheet. A cold cathode fluorescent lamp (“CCFL”) is often used as the light source.

FIG. 1 is a cross sectional view illustrating a conventional CCFL.

Referring to FIG. 1, a lamp 10 includes a discharge tube 1, an anode 3, a cathode 4, a phosphor 2, and a mixed gas 5.

More specifically, the discharge tube 1 has a shape of a transparent tube whose both ends are sealed. The phosphor 2 is disposed on an inner wall of the discharge tube 1. The anode 3 and a cathode 4 are arranged at both ends of the discharge tube 1, respectively, to receive an AC voltage from an external inverter 6. The mixed gas 5, which contains neon (Ne), argon (Ar), and mercury (Hg), is injected in the discharge tube 1.

When a high voltage is applied between the anode 3 and cathode 1, the mixed gas 5 is converted into plasma to radiate ultraviolet rays. The ultraviolet rays excite the phosphor 2 to emit visible light.

The conventional lamp 10 employs Ni as its electrode material which is inexpensive, well-processed, and easily mass-produced.

However, metal atoms or molecules can be released from the anode 3 due to sputtering occurring when the lamp 10 is activated, and such atoms or molecules can be bonded with Hg in the discharge tube 1. As a result, Hg amalgam may be yielded, so that the brightness of the lamp can be lowered. Moreover, the lifespan of the lamp can be reduced because the anode 3 can be quickly worn out by sputtering.

Furthermore, a rise in temperature caused by the high voltage applied to the anode 3 cause a discrepancy in temperature between the anode 3 and cathode 4 resulting in movement of the Hg molecules. As the Hg molecules move toward the cathode 4, as shown in FIG. 1, the amount of the Hg molecules in the anode 3 is reduced, so that pink discharges can be created at an area ‘A’.

### BRIEF SUMMARY OF THE INVENTION

An aspect of the present invention provides a lamp whose lifespan and brightness can be improved by employing a highly reliable metal as an electrode that is applied with a high voltage, and an LCD device having the same.

An exemplary embodiment of the present invention provides a lamp comprising: a discharge tube having an inner wall coated with a phosphor; a first electrode containing a first metallic material having a first sputtering rate provided at one end of the discharge tube and a second electrode containing a second metallic material having a second sputtering rate provided at the other end of the discharge tube, wherein the first sputtering rate is greater than the second sputtering rate.

The first electrode may be grounded, and the second electrode may be applied with a high voltage.

The first electrode may be formed of Ni or an alloy of Ni, and the second electrode may be formed of any one of niobium (Nb), molybdenum (Mo), tantalum (Ta), and tungsten (W).

The discharge tube may contain a mixed gas, a gas pressure of the mixed gas ranging from about 40 Torr to about 60 Torr.

Thermal conductivity of the second electrode may be higher than thermal conductivity of the first electrode.

A maximum allowable current of the first electrode may be about 8.5 mA, and a maximum allowable current of the second electrode may be about 10 mA.

Each of the first and second electrodes may be shaped as a cup whose inner side is recessed.

The discharge tube may be shaped as a letter “I” or “U”.

Another exemplary embodiment of the present invention provides a liquid crystal display device comprising: a liquid crystal display panel; and a lamp that supplies light to the liquid crystal display panel, the lamp comprising: a discharge tube having an inner wall coated with phosphor; a first electrode containing a first metallic material having a first sputtering rate provided at one end of the discharge tube; and a second electrode containing a second metallic material having a second sputtering rate provided at the other end of the discharge tube, wherein the first sputtering rate is greater than the second sputtering rate.

The liquid crystal display device may further comprise at least one inverter supplying a high voltage to the second electrode to drive the lamp.

A plurality of lamps may be provided at a rear surface of the liquid crystal panel.

The inverter may be provided to have the same number as the number of the lamps to separately drive the lamps.

The liquid crystal display device may further comprise a bottom chassis that receives the lamps, wherein the inverter is provided at a rear surface of the bottom chassis.

The liquid crystal display device may further comprise an optical sheet provided at an upper side of the lamps.

The lamps may be shaped as a letter “I” or “U”.

The liquid crystal display device may further comprise a light guide plate that guides light supplied from the lamp; an optical sheet provided at an upper side of the light guide plate; and a lamp cover that covers the lamp.

### BRIEF DESCRIPTION OF THE DRAWINGS

The present invention will become readily apparent by reference to the following detailed description when considered in conjunction with the accompanying drawings wherein:

FIG. 1 is a cross sectional view of a lamp for illustrating an occurrence of a poor discharge according to a prior art;

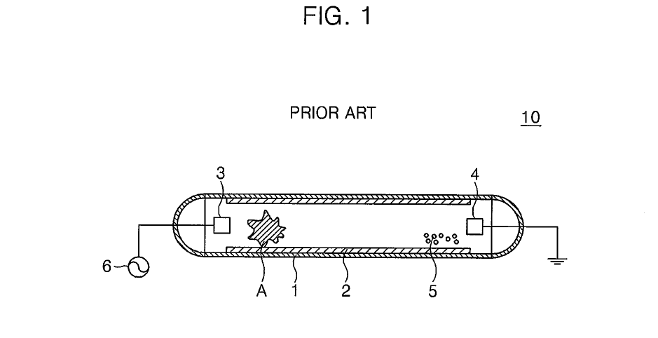

FIG. 2 is an exploded perspective view illustrating an LCD device according to a first exemplary embodiment of the present invention;

FIG. 3 is a cross sectional view of any one of lamps shown in FIG. 2;

FIG. 4 is a graph of showing a relationship between gas pressure and brightness of a lamp;

FIG. 5 is a graph of showing a relationship between temperature and brightness of a lamp;

FIG. 6 is a graph of showing a relationship between gas pressure and voltage of a lamp;

FIG. 7 is a perspective view of a rear surface of the LCD device according to the first exemplary embodiment of the present invention;

FIG. 8 is a perspective view of another lamp included in the LCD device according to the first exemplary embodiment of the present invention; and

FIG. 9 is an exploded perspective view of illustrating an LCD device according to a second exemplary embodiment of the present invention.

### DETAILED DESCRIPTION OF THE INVENTION

Hereinafter, the present invention will be described in detail with reference to the accompanying drawings.

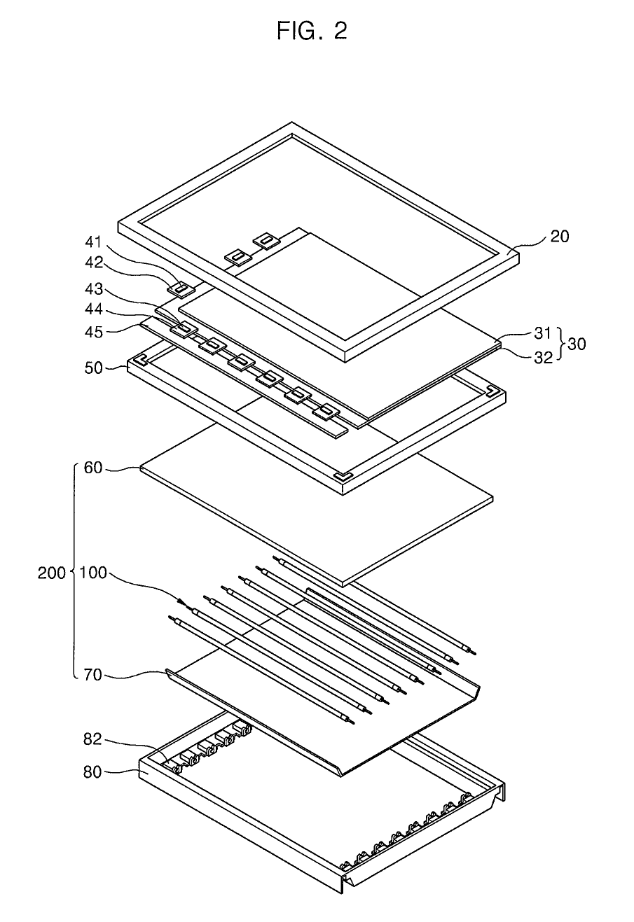

FIG. 2 is an exploded perspective view illustrating an LCD device according to a first exemplary embodiment of the present invention.

Referring to FIG. 2, an LCD device includes an LCD panel 30 and a backlight unit 200 for supplying light to the LCD panel 30. A direct-type backlight unit 200 is employed in FIG. 2.

More specifically, the LCD panel 30 includes a color filter substrate 31, a thin film transistor (“TFT”) substrate 32, and a liquid crystal layer interposed between the color filter substrate 31 and the TFT substrate 32. A color filter may be disposed at the color filter substrate 31, and TFTs are arranged on the TFT substrate 32. Sub-pixels are arranged in a matrix form on the LCD panel 30 and driven independently by the TFTs. The sub-pixels control the alignment of liquid crystal molecules by a voltage difference between a common voltage that is supplied to a common electrode and a pixel voltage that is supplied through the TFTs to a pixel electrode, and adjust light transmittance, thereby displaying images. The LCD panel 30 is a non-emission display element, so that the backlight unit 200 is necessary to emit light.

A panel driver is connected to the TFT substrate 32. The panel driver includes a gate driver 41, a data driver 43, a gate circuit film 42 on which the gate driver 41 is mounted, a data circuit film 44 on which the data driver 43 is mounted, and a printed circuit board (“PCB”) 45 on which driving elements such as a timing controller, etc. are arranged.

The gate driver 41 drives gate lines provided on the TFT substrate 32, and the data driver 43 drives data lines provided on the TFT substrate 32.

One side of the gate circuit film 42 is connected to the TFT substrate 32. One side of the data circuit film 44 is connected to the TFT substrate 32, and the other side thereof is connected to the PCB 45.

The gate and data circuit films 42 and 44 shown in FIG. 2 are chip-on-films (“COF”) or tape carrier packages (“TCP”). The gate and data drivers 41 and 43 may be mounted on the TFT substrate 32 in a chip-on-glass (“COG”) type, or during the formation of the TFTs.

The backlight unit 200 includes a plurality of lamps 100, an optical sheet 60, and a reflective sheet 70. The optical sheet 60 may include a diffusion sheet, a prism sheet, and a protection sheet which are sequentially arranged on the lamps 100. The diffusion sheet diffuses light supplied from the lamps 100 to make the brightness of the light uniform. A plurality of prisms may be rigidly arranged on the prism sheet. The prism sheet collects the light diffused by the diffusion sheet in the direction of the rear surface of the LCD panel 30. In general, the prism sheet consists of two sheets. Most of the light that has passed through the prism sheet is directed perpendicularly to the LCD panel 30 and provides uniform distribution of brightness. The protection sheet prevents the prism sheet from scratching. The optical sheet 60 is received at a mold frame 50. The LCD panel 30 is seated and fixed at the upper part of the mold frame 50.

The lamps 100 may be arranged in a bottom chassis 80 to keep a constant distance from each other. The lamps 100 may be inserted and fixed in sockets 82 provided at opposite sides of the bottom chassis 80.

Two lamp sockets 82 are provided per lamp 100. The number of pairs of lamp sockets 82 are provided to have the same number as that of the number of lamps 100. The outer part of the lamp socket 82 is made of an insulation material to prevent short circuits between the lamps 100.

A top chassis 20 may be provided to cover the non-display region of the LCD panel 30 and fix the LCD panel 30. The top chassis 20 may be combined with the bottom chassis 80.

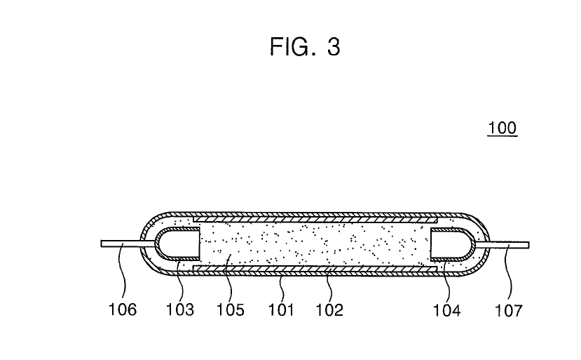

FIG. 3 is a cross sectional view of any one of lamps shown in FIG. 2.

Referring to FIG. 3, a lamp according to an exemplary embodiment of the present invention includes a discharge tube 101, a phosphor 102 provided on an inner wall of the discharge tube 101, a mixed gas 105 injected in the discharge tube 101, a first electrode 103 provided at one end of the discharge tube 101, and a second electrode 104 provided at the other end of the discharge tube 101.

More specifically, the discharge tube 101 is formed of a transparent material, such as glass, in the shape of the letter ‘I’. The phosphor 102 is disposed on the inner wall of the discharge tube 101. The phosphor 102 is made of a fluorescent material, including rare-earth elements such as yttrium (Y), cerium (Ce), terbium (Tb), etc. that can emit visible light by the illumination of ultraviolet rays. The mixed gas includes Hg, Ne, and Ar in the discharge tube 101.

The first electrode 103 may be provided at one of two ends of the discharge tube 101. The first electrode 103 may be connected to a first lead 106 that passes through the inner and outer wall of discharge tube 101. The first lead 106 may be grounded to connect the first electrode 103 to ground. Nickel (Ni) or its alloy that is inexpensive may be used for the first electrode 103. The current to be applied to the first electrode 103 may be limited within about 8.5 mA. When the current of more than about 8.5 mA is applied to the first electrode 103, a fuse included in an external inverter may be cut off.

The second electrode 104 may be provided at the other end of the discharge tube 101. The second electrode 104 may be connected to the high-voltage terminal of the external inverter through a second lead 107 that passes through the inner and outer wall of discharge tube 101, so that a high voltage may be applied to the second electrode 104. The external inverter converts a DC input voltage into an AC high voltage and supplies the AC high voltage to the second electrode 104. Accordingly, a high voltage of several ten or several thousand volts may be applied to the second electrode 104. In the exemplary embodiment of the present invention, the high voltage may be applied only to the second electrode 104. The current to be applied to the second electrode 104 may be limited to within about 10 mA. When a current of more than about 10 mA is applied to the second electrode 104, the temperature of the second electrode 104 may increase so that deterioration of the lamp 100 can advance, and the fuse included in the external inverter may be cut off to limit the deterioration. Accordingly, the current to be applied to the second electrode 104 may be limited to less than about 10 mA.

When a high voltage is applied between the first and second electrodes 103 and 104, a tube current flows from the second electrode 104 to the first electrode 103. Negative ions emitted from the first electrode 103 collide with particles of the mixed gas 105, so that a chain reaction is caused in the discharge tube 101, thus producing plasma. The phosphor 102 is excited by ultraviolet rays generated from the plasma to radiate visible light. In other words, an electric field is generated from the second electrode 104 to the first electrode 103. The negative ions excited from the mixed gas 105 while the plasma is generated move along the electric field. The negative ions move toward and collide against the second electrode 104 of positive polarity. When the negative ions collide against the second electrode 104, the second electrode 104 may become worn out. That is, sputtering may occur at the second electrode 104. Accordingly, the second electrode 104 may be formed of any one of niobium (Nb), tantalum (Ta), molybdenum (Mo), and tungsten (W) which is highly resistant to sputtering.

The sputtering-resistance properties of the electrode can be measured by testing a sample from the electrode for a prescribed time while prescribed conditions, such as acceleration voltage, acceleration current, incident angle, and gas pressure, are kept constant to calculate the sputtering rate by measuring the depth of holes created by the sputtering.

Table 1 shows the sputtering rate for Nb which was measured with respect to Ni under the same conditions as those of Ni.

TABLE 1

| Material | Sputtering rate |
|---|---|
| Ni | 100% |
| Nb | 50% |

As can be seen from Table 1, Nb has greater hardness and better sputtering resistance properties when compared to Ni. Accordingly, when Nb is employed for the second electrode 104, the lifespan of the electrode 104 is doubled since the Nb sputtering rate amounts to half the sputtering rate of Ni as measured under the same conditions as those of Ni. In addition, even if the amount of current applied to the lamp 100 increases, the lifespan can be lengthened compared to a case where Ni is used for the electrode 104.

When metals other than Nb, i.e. Ta, Mo, and W are used for the electrode 104, their sputtering rates are also smaller than that of Ni. Accordingly, when metals such as Ta, Mo, and W are employed for the second electrode 104, the sputtering-resistance properties can be improved compared to a case where Ni is used for the second electrode 104, so that the lifespan of the lamp 100 can be increased.

When the sputtering-resistance properties of the second electrode 104 are improved, the gas pressure can be lowered to improve the brightness of the lamp 100.

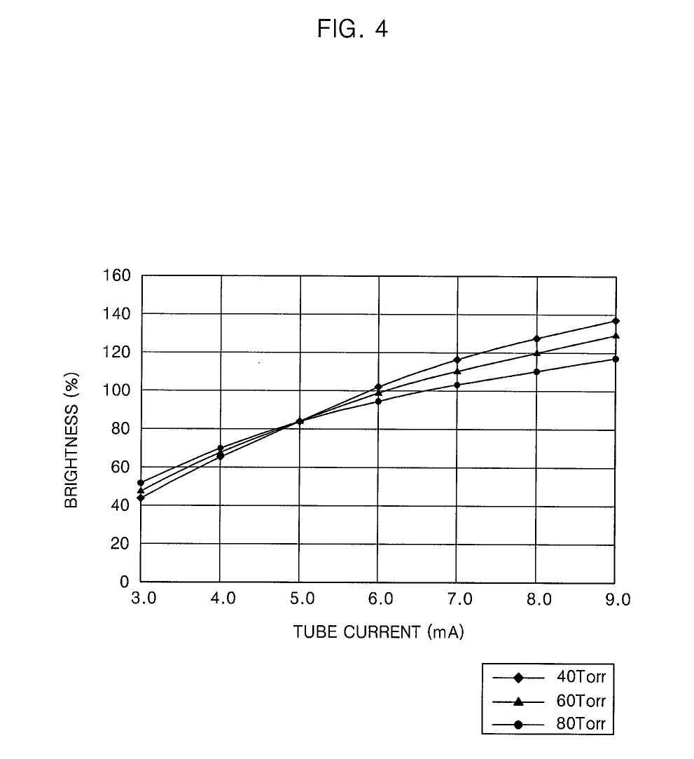

FIG. 4 is a graph of showing a relationship between gas pressure and tube current of a lamp.

FIG. 4 also shows the uniformity of brightness measured at the gas pressure of 40 Torr, 60 Torr, and 80 Torr while the temperature of the lamp 100 is 25° C.

Referring to FIG. 4, as the gas pressure becomes lower at a current of more than a reference tube current (6 mA), the light emitted by the discharge tube 101 is correspondingly brighter.

More specifically, the slope of a curved line that indicates a relationship between the tube current and brightness becomes different depending on the gas pressure in the discharge tube 101. That is, when the gas pressure is 80 Torr, although the tube current increases, the increasing rate of brightness is relatively low, and therefore, the slope of the curved line gently increases. However, when the tube current increases while the gas pressure is 60 Torr or 40 Torr, the increasing rate of brightness is relatively higher. As a result, the curved line of tube current-brightness at lower pressure is increased with a larger slope than in the gas pressure of 80 Torr.

As the gas pressure increases while the gas pressure is less than the reference tube current (6 mA), the brightness of emissive light is correspondingly high. In the gas pressure of more than the reference tube current (6 mA), however, the lower gas pressure, the brighter the light emitted. In general, because the tube current supplied to the lamp 100 is more than the reference tube current (6 mA), the gas pressure may be kept lower in the discharge tube 101 to emit brighter light. Accordingly, the gas pressure may be kept in the range from about 40 Torr to about 60 Torr.

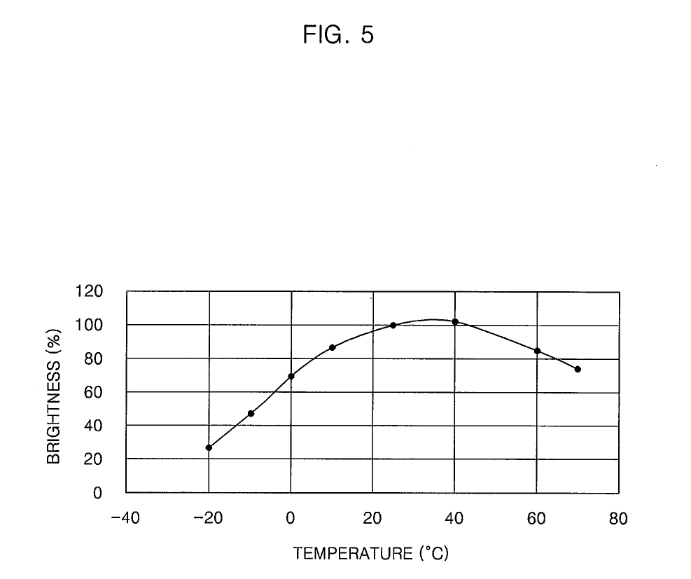

More specifically, as the gas pressure becomes higher in the discharge tube 101, the collision of molecules of mixed gas is increased in the course of generation of plasma, so that the temperature of the discharge tube 101 is raised. At the temperature of more than a prescribed temperature (e.g., 35° C.), vaporized Hg absorbs ultraviolet rays, so that as the temperature increases, the brightness may be decreased as shown in FIG. 5, which shows a relationship of temperature-brightness of the lamp 100. Accordingly, the gas pressure may be kept less than 60 Torr in the discharge tube 101 to reduce the increase in temperature that may occur.

When the gas pressure is less than about 40 Torr in the discharge tube 101, the density of gas is decreased and therefore the collision of molecules of mixed gas is reduced, thus increasing mean free path (“MFP”) of negative ions. Accordingly, the energy of the negative ions colliding against the second electrode 104 is increased. As such, when the MFP of negative ions is increased, the second electrode 104 may be more rapidly worn out by the negative ions colliding with the second electrode 104, thereby lessening the lifespan of the lamp 100.

In addition, when the gas pressure is less than about 40 Torr and therefore the MFP is higher so that the energy of colliding against the second electrode 104 is increased, the temperature of the second electrode 104 is higher, which may increase the temperature difference between the first and second electrodes 103 and 104. Accordingly, the gas pressure may be kept higher than about 40 Torr in the discharge tube 101.

When the gas pressure is 40 Torr, the MFP of negative ions is larger than in 60 Torr, and therefore, the energy of negative ions colliding against the second electrode 104 is increased. Accordingly, a metal such as Nb, Ta, Mo, and W may be used to guarantee a minimum specified period of lifespan even when the second electrode 104 is under the gas pressure of 40 Torr.

As the gas pressure of the discharge tube 101 is lower, the voltage applied to the second electrode 104 may be correspondingly lowered according to an exemplary lamp 100 of the present invention.

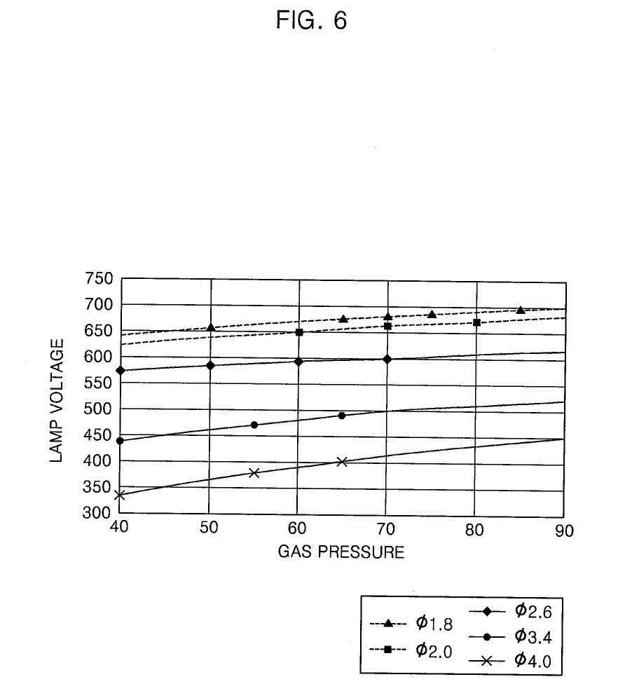

FIG. 6 is a graph of showing a relationship between the gas pressure and a voltage applied to the lamp 100, wherein the lamps that are 315 mm long and different in diameter from each other are used while a tube current of 6 mA at a temperature of 25° C. is supplied across the lamps, and for the same fixed brightness for all lamps.

Referring to FIG. 6, as the gas pressure of discharge tube 101 is decreased, the lower voltage is correspondingly applied to the second electrode 104. That is, although there is more and less difference depending on the diameter ø of each lamp 100, each lamp 100 may acquire the same brightness as the others even when lower voltage is applied to the lamp 100 under a lower gas pressure. Accordingly, the voltage supplied by the inverter is decreased, and therefore, the capacity or winding ratio of the inverter may be lessened. And, the initial driving voltage of the lamp 100 may be reduced.

As a result, the power consumption of the lamp 100 may be improved by about 5% to 6% at the gas pressure of 40 Torr compared to where the gas pressure is 60 Torr in the same brightness. Therefore, the efficiency of the lamp 100 may be improved by about 10%. As such, the gas pressure may be 40 Torr.

More heat may be generated at the second electrode 104 under the gas pressure of 40 Torr than under the gas pressure of 60 Torr. In particular, in a single side driving type where a high voltage is applied only to the second electrode 104, more heat is generated at the second electrode 104 than at the first electrode. When the temperature is higher at the second electrode 104 than at the first electrode 103, a discrepancy occurs at the temperature of the discharge tube 101, so that malfunctions such as pink discharges may be created. Therefore, such a discrepancy between the first and second electrodes 103 and 104 may be removed. Accordingly, the second electrode 104 may be formed of any one of Nb, Ta, Mo, and W, which has good thermal conductivity. A metal such as Nb, Ta, Mo, and W is higher in thermal conductivity than Ni, so that heat generated from the second electrode 104 may be dissipated to the outside more rapidly. As a consequence, Hg is inclined toward the first electrode 103 in the discharge tube 101, so that the pink discharge can be prevented.

The first and second electrodes 103 and 104 may be shaped as cups to make the effective area larger, thus improving the reliability of electrodes. As shown in FIG. 3, the first and second electrodes 103 and 104, respectively, may be formed to have a shape of a cup whose inside is recessed. When the first and second electrodes 103 and 104 are formed as above, their surface areas, i.e. effective electrode surface areas may be broadened. When the effective electrode surface areas of the first and second electrodes 103 and 104 are broadened, although the same tube current is applied to the lamp 100, the area density of negative ions that collide against the same cross section is reduced, thus reducing the likelihood of the electrode abrasion by sputtering. Accordingly, the lifespan of the second electrode 104 may be lengthened.

In addition, as the length of the second electrode 104 is longer, the lifespan of the lamp 100 may be correspondingly increased. That is, when the length of the second electrode 104 increases, the time which it takes for the second electrode 104 to wear out is lengthened, so that the lifespan of the lamp 100 may be extended.

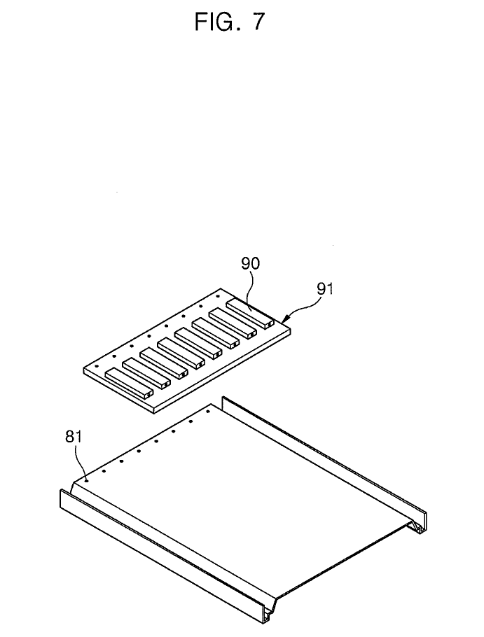

FIG. 7 is a perspective view of a rear surface of the LCD device according to the first exemplary embodiment of the present invention.

Referring to FIG. 7, a rear surface of the LCD device according to an exemplary embodiment of the present invention includes an inverter PCB 91 fixed in the rear surface of a bottom chassis 80. The inverter PCB 91 includes a plurality of inverters 90 mounted thereon.

More specifically, the bottom chassis 80 includes a plurality of connection holes 81 that pass through the bottom chassis 80 to connect the inverters 90 with the lamps 100. The connection holes 81 are provided to go through the region where the lamp sockets 82 shown in FIG. 2 are placed. The connection holes 81 serve as pathways through which conductive lines (not shown) pass to connect the second electrodes 104 of the lamps 100 with the inverters 90.

The number of the inverters 90 may be the same as that of the lamps 100 to supply tube currents to the lamps 100. The inverters 90 are arranged parallel with each other along the long side of the inverter PCB 91. The inverter PCB 91 is arranged at the rear surface of the bottom chassis 80. The inverter PCB 91 is placed at a part of the rear surface of the bottom chassis 80 where the second electrode 104 is provided so that the second electrode 104 of the lamp 100 can be easily coupled with the inverter 90. The first electrode 103 of the lamp 100 may be connected to the ground of the inverter 90, or connected directly to the bottom chassis 80.

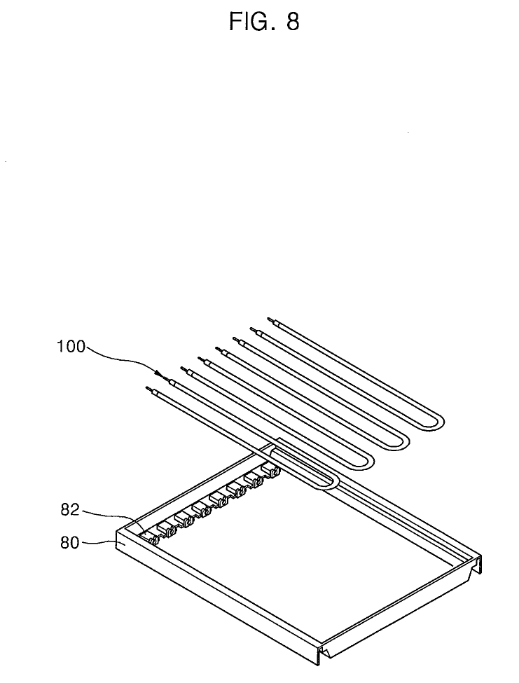

FIG. 8 is a perspective view of another lamp included in the LCD device according to the first exemplary embodiment of the present invention.

Referring to FIG. 8, a lamp 100 includes a discharge tube, a phosphor provided on an inner wall of the discharge tube, a mixed gas injected in the discharge tube, a first electrode connected to a ground, and a second electrode applied with a high voltage. The first electrode may be formed of Ni or an alloy of Ni. The second electrode may be formed of a metal such as Nb, Ta, Mo, and W that is lower in sputtering rate than the first electrode. The lamp 100 may be shaped as the letter “U”. When the lamp 100 is formed to have a shape of the letter “U”, the number of lamps 100 and the number of inverters 90 may be reduced. And, the lamp sockets 82 are provided only at one side of the bottom chassis 80, and therefore, the costs can be reduced.

In addition, since the first and second electrodes 103 and 104 are both provided at one side of the LCD device, the length of a wire that connects the first electrode 103 to the ground may be reduced.

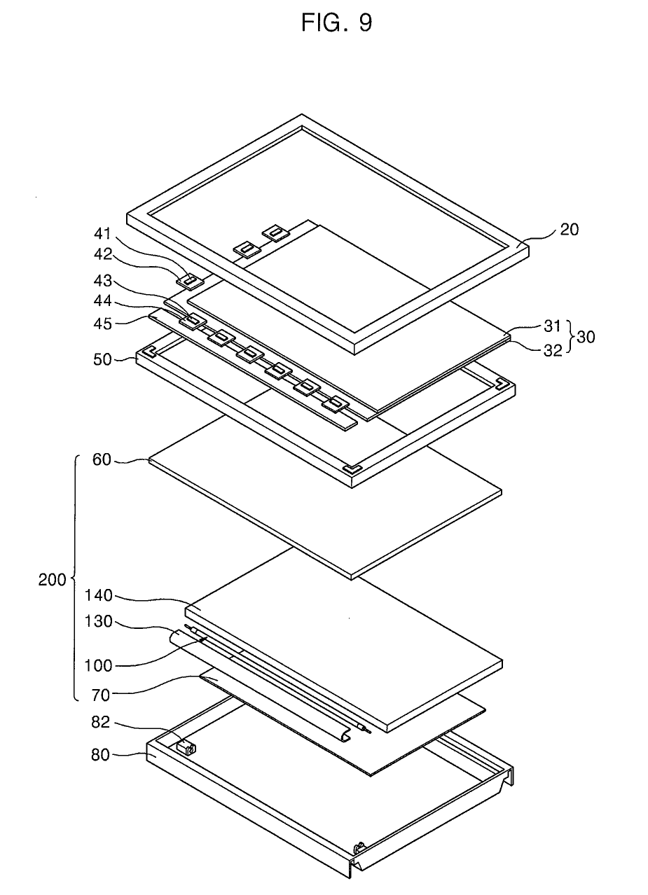

FIG. 9 is an exploded perspective view illustrating an LCD device according to a second exemplary embodiment of the present invention. An edge-type backlight unit is used in FIG. 9 unlike in FIG. 2. The components in FIG. 9 such as an LCD panel 30, a gate driver 41, a gate circuit film 42, a data driver 43, a data circuit film 44, a PCB 45, and a mold frame 50 are identical to those in FIG. 2, and therefore, their repetitive descriptions will be omitted.

Referring to FIG. 9, an edge-type backlight unit 200 includes a lamp 100, a light guide plate 140, and a lamp cover 130.

The light guide plate 140 is provided at the rear surface of the LCD panel 30. The light guide plate 140 whose incident surface faces the lamp 100 converts a line-type light source to a surface-type light source and supplies the surface-type light source from the incident surface to the LCD panel 30. The light guide plate 140 includes a plurality of grooves or protrusions each of which is shaped as the letter “V” to guide the light through refraction or reflection from its incident side to another side that is opposite to the incident side.

The lamp cover 130 covers the outer surface of the lamp 100 to protect the lamp 100 from external physical impacts. And, the lamp cover 130 improves optical usage efficiency by reflecting the light from the lamp 100 to the incident surface of the light guide plate 140.

The backlight unit 200 may further include an optical sheet 60 and a reflective sheet 70 to make the light supplied from the light guide plate 140 uniform and improve the optical efficiency.

The optical sheet 60 includes a diffusion sheet, a prism sheet, and a protection sheet which are sequentially stacked on the light guide plate 140. The reflective sheet 70 that is provided at the rear surface of the light guide plate 140 reflects light from the lower part of the light guide plate 140 to the light guide plate 140.

The lamp 100 is identical to that shown in FIG. 3. The backlight unit 200 may use two or more lamps 100 to increase the brightness of light supplied to the LCD panel 30. The lamp 100 may be shaped as the letter “U” as in FIG. 8.

The backlight unit 200 further includes inverters (not shown in FIG. 9). The inverters supply high voltage to the second electrode 104 of the lamp 100 as shown in FIG. 2. The number of inverters may be identical to that of lamps 100. The inverters may be provided at the rear surface of the bottom chassis 80 or lower part of the top chassis 20.

As mentioned above, the backlight unit according to an exemplary embodiment of the present invention and the LCD device having the same, may reduce the cost of lamp usage by employing a metal such as Nb, Ta, Mo, and W for the second electrode that is applied with high voltage and Ni for the first electrode that is grounded.

Additionally, since the metal such as Nb, Ta, Mo, and W may be used for the second electrode that is applied with high voltage, the probability for the electrode wearing out may be reduced, so that the lifespan of the lamp can be extended.

Moreover, the gas pressure of the mixed gas injected in the discharge tube is reduced, so that the brightness may be increased and power consumption may be lessened.

In addition, since the thermal conductivity of the second electrode is higher than that of the first electrode, thermal balance of the lamp may be kept constant, so that pink discharges can be prevented.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A lamp comprising:
a discharge tube having an inner wall coated with a phosphor;
a first electrode containing a first metallic material having a first sputtering rate provided at one end of the discharge tube; and
a second electrode containing a second metallic material having a second sputtering rate provided at the other end of the discharge, wherein
the first sputtering rate is larger than the second sputtering rate.

2. The lamp of claim 1, wherein the first electrode is grounded, and the second electrode is applied with a high voltage.

3. The lamp of claim 2, wherein the first electrode is formed of nickel (Ni) or an alloy of nickel (Ni), and the second electrode is formed of any one of niobium (Nb), molybdenum (Mo), tantalum (Ta), and tungsten (W).

4. The lamp of claim 3, wherein
the discharge tube contains a mixed gas, a gas pressure of the mixed gas ranging from about 40 Torr to about 60 Torr.

5. The lamp of claim 4, wherein thermal conductivity of the second electrode is higher than thermal conductivity of the first electrode.

6. The lamp of claim 3, wherein a maximum allowable current of the first electrode is about 8.5 mA, and a maximum allowable current of the second electrode is about 10 mA.

7. The lamp of claim 3, wherein each of the first and second electrodes is shaped as a cup whose inner side is recessed.

8. The lamp of claim 3, wherein the discharge tube is shaped as a letter “I” or “U”.

9. A liquid crystal display device comprising:
a liquid crystal display panel; and
a lamp to supply light to the liquid crystal display panel, the lamp comprising:
a discharge tube having an inner wall coated with a phosphor;
a first electrode containing a first metallic material having a first sputtering rate provided at one end of the discharge tube; and
a second electrode containing a second metallic material having a second sputtering rate provided at the other end of the discharge tube, wherein
the first sputtering rate is larger than the second sputtering rate.

10. The liquid crystal display device of claim 9, wherein the first electrode is grounded, and the second electrode is applied with a high voltage.

11. The liquid crystal display device of claim 10, wherein the first electrode is formed of Ni or an alloy of Ni, and the second electrode is formed of any one of niobium (Nb), molybdenum (Mo), tantalum (Ta), and tungsten (W).

12. The liquid crystal display device of claim 11, further comprising at least one inverter supplying a high voltage to the second electrode to drive the lamp.

13. The liquid crystal display device of claim 12, wherein a plurality of lamps are provided at a rear surface of the liquid crystal panel.

14. The liquid crystal display device of claim 13, wherein the inverter is provided to have the same number as the number of the lamps to separately drive the lamps.

15. The liquid crystal display device of claim 14, further comprising a bottom chassis to receive the lamps, wherein the inverter is provided at a rear surface of the bottom chassis.

16. The liquid crystal display device of claim 15, further comprising an optical sheet provided at an upper side of the lamps.

17. The liquid crystal display device of claim 16, wherein the lamps are shaped as a letter “I” or “U”.

18. The liquid crystal display device of claim 12, further comprising:
a light guide plate that guides light supplied from the lamp, wherein the light guide plate has an upper side facing toward the liquid crystal display panel;
an optical sheet provided at an upper side of the light guide plate between the light guide plate and the liquid crystal display panel; and
a lamp cover that covers the lamp.

19. The liquid crystal display device of claim 10, wherein thermal conductivity of the second electrode is higher than thermal conductivity of the first electrode.
